(19) United States
(12) Patent Application Publication
(10) Pub. No.: US 2008/0316864 A1
(43) Pub. Date: Dec. 25, 2008

(54) SPRING BASED FINE ACOUSTIC WAVEGUIDE

(75) Inventor: Nir Klein, Rishpon (IL)

Correspondence Address: Active Knowledge Ltd., POB 294, Kiryat Tivon, 36010, omitted

(73) Assignee: Source Of Sound Ltd., Netanya (IL)

(21) Appl. No.: 12/143,858

(22) Filed: Jun. 23, 2008

Related U.S. Application Data
(60) Provisional application No. 60/946,102, filed on Jun. 25, 2007.

(51) Int. Cl. H04B 1/02

(52) U.S. Cl. 367/138

(57) ABSTRACT

A fine acoustic waveguide comprising an inner spring. The inner spring provides stability to the acoustic waveguide and increases the manufacturing yield. The disclosed methods further comprise the steps of bending the fine acoustic waveguide with the inner spring and placing a securing material over the bent fine acoustic waveguide, optionally by using mold injection, casting, or extrusion coating.

### FIELD OF THE INVENTION

The embodiments of the present invention relate to an acoustic waveguide and, more particularly, to a spring based fine acoustic waveguide, wherein the fine acoustic waveguide comprises an inner helix spring that provides stability to the acoustic waveguide and increases the manufacturing yield.

### BACKGROUND

Complete theoretical descriptions, details, explanations, examples, and applications of the subjects and phenomena related to acoustic waveguides, springs, and casting or molding techniques, are readily available in standard references in the fields of acoustics and mechanical engineering.

### BRIEF DESCRIPTION OF THE DRAWINGS

The discussed embodiments are herein described, by way of example only, with reference to the accompanying drawings. With specific reference now to the drawings, it is stressed that the particulars shown are by way of example and for purposes of illustrative discussion of the embodiments only, and are presented in order to provide what is believed to be the most useful and readily understood description of the principles and conceptual aspects of the embodiments. In this regard, no attempt is made to show structural details of the embodiments in more detail than is necessary for a fundamental understanding of the invention. In the drawings:

FIGS. 1A and 1B are illustrations of a fine tube with an inner spring in accordance with one embodiment of the present invention;

FIG. 2A is an illustration of a curved fine tube with an inner spring in accordance with one embodiment of the present invention;

FIG. 2B is an illustration of a curved fine tube with an inner spring placed in a securing material, in accordance with one embodiment of the present invention;

FIG. 3A is an illustration of a curved spring with an inner wire in accordance with one embodiment of the present invention;

FIG. 3B is an illustration of a curved spring with an inner wire placed in a securing material, in accordance with one embodiment of the present invention;

FIG. 4 is an illustration of a curved spring placed in a high viscosity securing material, in accordance with one embodiment of the present invention;

FIG. 5 is an illustration of one method, in accordance with one embodiment of the present invention;

FIG. 6 is an illustration of one method, in accordance with one embodiment of the present invention;

FIG. 7 is an illustration of one method, in accordance with one embodiment of the present invention;

FIG. 8 is an illustration of one method, in accordance with one embodiment of the present invention;

### DETAILED DESCRIPTION

Some of the embodiments, discussed in detail below, describe methods and devices for bending fine acoustic waveguides. It is to be understood that the embodiments are not limited by the details of construction, arrangement, and composition of the components of the devices and methods set forth in the following description, drawings or examples. While specific configurations and arrangements are discussed, it is to be understood that this is done for illustrative purposes only. A person skilled in the relevant art will recognize that other embodiments, configurations and arrangements can be used without departing from the spirit and scope of the embodiments of the present invention.

The disclosed embodiments are capable of other embodiments and/or of being practiced or carried out in various ways. Also, it is to be understood that the phraseology, terminology and notation employed herein are for the purpose of description and should not be regarded as limiting.

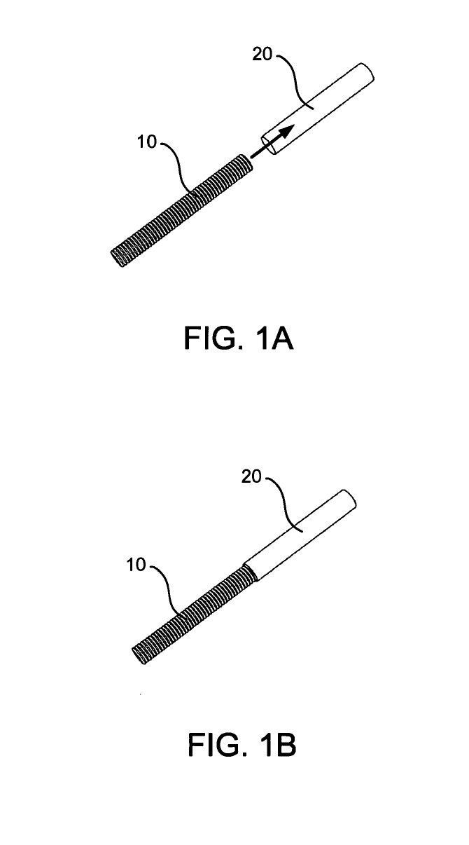

Referring to FIG. 1B, in one embodiment of the invention, a fine acoustic waveguide 20 comprises an inner helix spring 10. The spring 10 may provide stability to the acoustic waveguide 20 and may increase the manufacturing yield as described below.

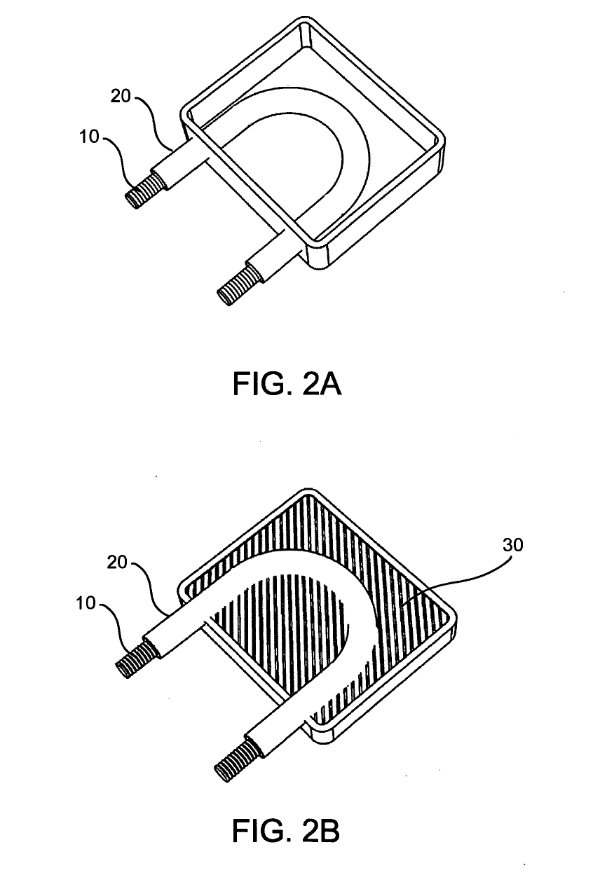

Optionally, the spring 10 may extend along the acoustic waveguide 20, such as illustrated in FIG. 2A. Alternatively (not shown in the figures), the spring 10 may extend along the section of the acoustic waveguide to be bent; wherein the bending may occur during the production process and/or during the course of use of a device that includes the acoustic waveguide 20.

In one embodiment, the spring 10 is sufficiently flexible to permit the acoustic waveguide 20 to be bent—during a production process and/or during the course of use of a device that includes the acoustic waveguide 20—without changing or reducing the cross-section of the acoustic waveguide. At the same time, the spring 10 should be sufficiently rigid to resist significant collapse of the acoustic waveguide 20 during the production process and/or during the use of the product, when applicable.

In one embodiment of the invention, the helix spring 10 is sufficiently flexible to permit a reasonable bend of the acoustic waveguide 20 while providing structural strength to the acoustic waveguide 20 and ensuring that the structure is sufficiently rigid to resist significant collapse of the elongated passage when casting or molding around the acoustic waveguide 20 or performing any other manufacturing activities such connecting the acoustic waveguide 20 to a device, shortening the acoustic waveguide 20, binding the acoustic waveguide 20 to an element, etc.

FIG. 2B illustrates an acoustic waveguide 20 with an inner spring 10, which is bent and affixed by a securing material 30. Without limiting the embodiments, the securing material 30 may be created using a casting, molding or extrusion process.

For the sake of simplicity, the embodiments are illustrated using a helix spring, but it is to be understood that the disclosed embodiments are not limited to a helix spring, which is also known as coil or coiled spring. The spring in the embodiments may be made of stainless steel, beryllium-copper compression, carbon, or any other material supplying the required characteristics. Optionally, the helix spring may be replaced by other forms of springs such as a straight length spring, spring tempered hollow rod, or any other appropriate equivalent that extends along the length of the hollow tube and is adjacent to the wall of the sound waves passage. Optionally, the spring may be replaced by a metallic, plastic or elastic tube or tubular structure that is at least slightly more rigid than the acoustic waveguide 20 and is able to resist the collapse of the passage upon bending, casting, molding or other processes. In some of the embodiments, the spring may also be replaced by a support in the form of a series of separate rings. The rings may be embedded in the hollow body or otherwise positioned adjacent to the passage along the hollow body's length to prevent excessive changes in the cross-sectional shape of the acoustic waveguide. Without limiting the embodiments, the rings may be made of plastic, metallic or elastomeric material. It is to be understood that the springs used in the various embodiments are only examples of means for resisting or preventing the collapse of the acoustic waveguide and other alternatives may also be used.

Optionally, the acoustic waveguide may be made of a thermo plastic Elastomer material, such as Polyolefin, Polyethylene, and Poly Vinyl Chloride (PVC). Alternatively, the acoustic waveguide may be made of another material having appropriate characteristics.

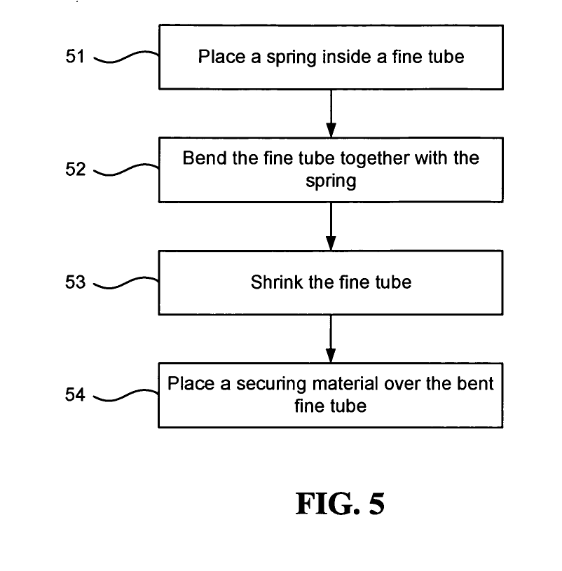

Referring to FIG. 1A, FIG. 1B, FIG. 2A, FIG. 2B, and FIG. 5, in one embodiment, the following method is used for manufacturing a curved acoustic waveguide.

In step 51, placing a helix spring 10 inside a fine tube 20, as illustrated by FIG. 1A.

In step 52, bending the fine tube 20 together with the spring 10, as illustrated in FIG. 2A.

Optionally, in step 53, shrinking the fine tube 20 to tightly surround the spring 10. It is to be understood that the step of shrinking the fine tube may occur before or after the step of bending the fine tube. In one example, the tube is of the shrink sleeve type and is shrunk by heat.

And, optionally, in step 54, placing a securing material 30 over the bent fine tube 20 with the inner spring 10, as illustrated in FIG. 2B. Wherein the step of placing the securing material 30 over the fine tube 20 comprises a process such as, but not limited to, mold injection, casting, and extrusion coating.

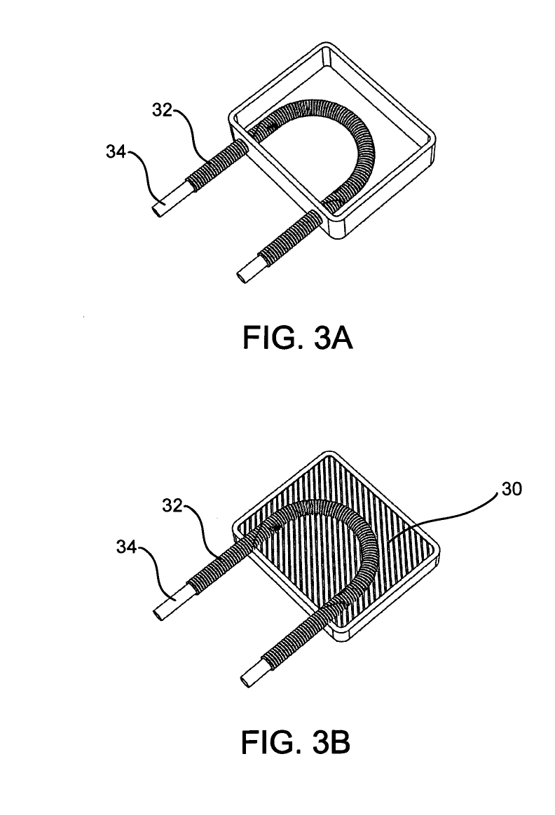

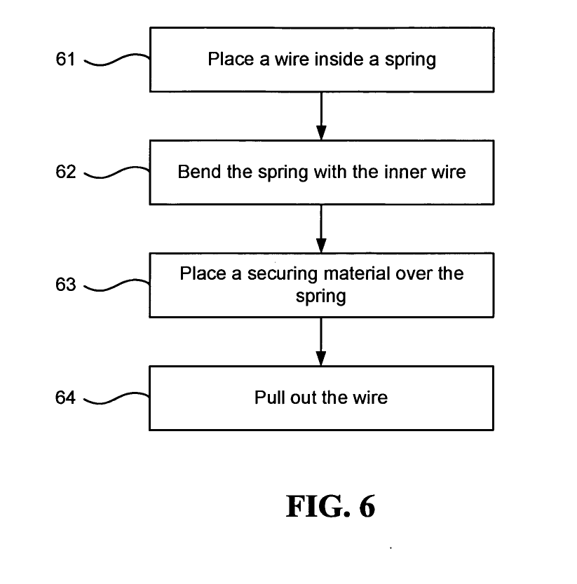

Referring to FIG. 3A, FIG. 3B, and FIG. 6, in one embodiment, the following method is used for manufacturing a curved acoustic waveguide.

In step 61, placing a wire 34 inside a spring 32.

In step 62, bending the spring 32 with the inner wire 34, as illustrated in FIG. 3A.

In step 63, placing a securing material 30 over the spring 32 with the inner wire 34, as illustrated in FIG. 3B. Wherein the step of placing the securing material 30 over the spring 32 comprises a process such as, but not limited to, mold injection, casting, and extrusion coating. And wherein the inner wire 34 prevents the securing material 30 from entering inside the spring 32.

And in step 64, pulling out the wire. After the inner wire 34 is pulled out, a fine curved acoustic waveguide is obtained.

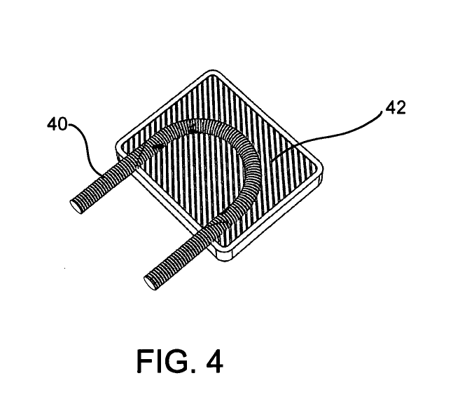

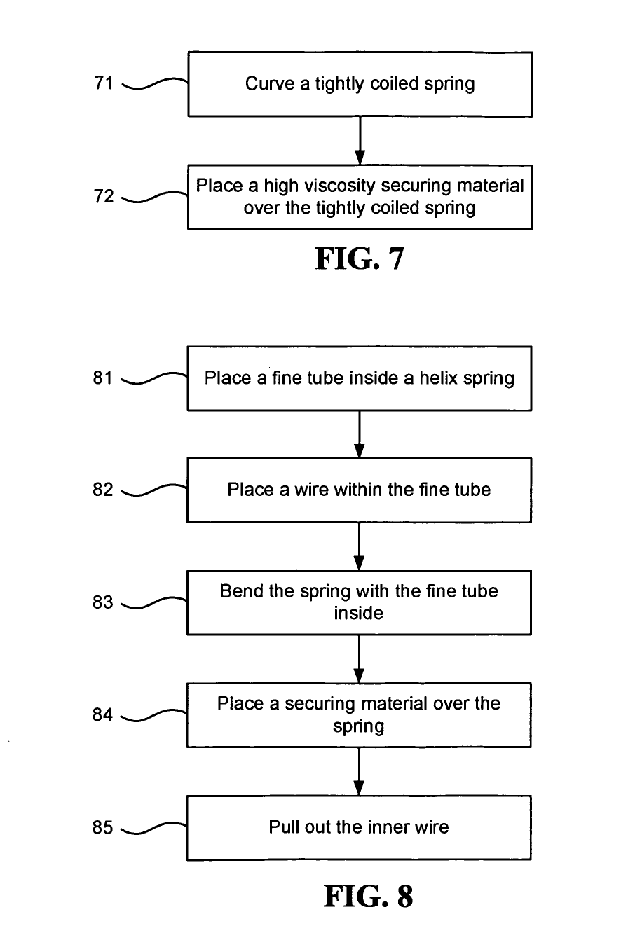

Referring to FIG. 4 and FIG. 7, in one embodiment, the following method is used for manufacturing a curved acoustic waveguide.

In step 71, curving a tightly coiled spring. A tightly coiled spring 40 (i.e., a spring whose coils are in contact with one another) is used for forming the acoustic wave guide.

In step 72, placing a securing material 42 over the tightly coiled spring 40, wherein the securing material 42 features high viscosity. The high viscosity prevents the securing material 42 from entering into the acoustic wave guide inside the tightly coiled spring 40. The greater the degree to which the tightly coiled spring 40 is bent, the higher the viscosity of the securing material 42 should be.

Optionally, the step of placing the securing material 42 over the tightly coiled spring 40 comprises a performing process such as, but not limited to, mold injection, casting, and extrusion coating.

Referring to FIG. 8, in one embodiment, the following method is used for manufacturing a curved acoustic waveguide.

In step 81, placing a fine tube inside a helix spring.

Optionally, in step 82, placing a wire within the fine tube, whereby the wire prevents the fine tube from collapsing while bending the acoustic waveguide.

In step 83, bending the spring with the fine tube inside, wherein the bending radius is limited by the characteristics of the fine tube.

And in step 84, placing a securing material over the spring with the fine tube inside. Wherein the step of placing a securing material over the spring with the fine tube inside comprises performing a process such as, but not limited to, mold injection, casting, and extrusion coating.

And optionally, in step 85, pulling out the inner wire after the securing material is placed.

It is to be understood that the embodiments are not limited in their applications to the details of operation or implementation of the devices and methods set in the description, drawings, or examples.

While the embodiments have been described in conjunction with specific examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

What is claimed is:

1. A fine acoustic waveguide comprising an inner spring covered by a tube; wherein the inner spring is sufficiently flexible to permit the fine acoustic waveguide to be bent without significantly changing the cross-section of the fine acoustic waveguide.

2. The fine acoustic waveguide of claim 1, wherein the inner spring is sufficiently rigid to resist significant collapse of the fine acoustic waveguide during a production process or during its utilization.

3. The fine acoustic waveguide of claim 1, wherein the inner spring extends along the entire acoustic waveguide.

4. The fine acoustic waveguide of claim 1, wherein the inner spring extends along a section of the acoustic waveguide.

5. A method comprising the step of bending the fine acoustic waveguide of claim 4 along the section comprising the inner spring.

6. The fine acoustic waveguide of claim 1, wherein the inner spring is sufficiently flexible to permit a reasonable bending of the fine acoustic waveguide while providing structural strength to the fine acoustic waveguide and ensuring that the structure is sufficiently rigid to resist significant collapse of the acoustic waveguide's elongated passage when casting or molding around the fine acoustic waveguide.

7. The fine acoustic waveguide of claim 1, wherein the inner spring is sufficiently flexible to permit a reasonable bending of the fine acoustic waveguide while providing structural strength to the fine acoustic waveguide and ensuring that the structure is sufficiently rigid to resist significant collapse of the acoustic waveguide's elongated passage when performing manufacturing activities.

8. The fine acoustic waveguide of claim 7, wherein the manufacturing activities comprise at least one of the following activities: connecting the fine acoustic waveguide to a device, shortening the fine acoustic waveguide, or binding the fine acoustic waveguide to an element.

9. The fine acoustic waveguide of claim 1, wherein the fine acoustic waveguide is bent and affixed by securing material.

10. The fine acoustic waveguide of claim 9, wherein the securing material is created using one or more of the following methods: casting, molding, or an extrusion process.

11. The fine acoustic waveguide of claim 1, wherein the inner spring is an inner helix spring.

12. The fine acoustic waveguide of claim 1, wherein the inner spring is selected from the group of: straight length spring, spring tempered hollow rod, or elastic element that extends along the length of the tube.

13. The fine acoustic waveguide of claim 1, wherein the tube comprises at least one of the following materials: Polyolefin, Polyethylene, Poly Vinyl Chloride, or a thermo plastic Elastomer.

14. A fine acoustic waveguide comprising a hollow tube and means for supporting the hollow tube to permit the hollow tube to be bent without significantly changing the cross-section of the hollow tube.

15. The fine acoustic waveguide of claim 14, wherein the means for supporting the hollow tube is selected from the group of: helix spring, straight length spring, spring tempered hollow rod, or elastic element that extends along the length of the tube.

16. The fine acoustic waveguide of claim 14, wherein the means for supporting the hollow tube comprises a metallic, plastic or elastic tube or tubular structure that is at least slightly more rigid than the hollow tube and is able to resist the collapse of the acoustic waveguide passage upon bending.

17. The fine acoustic waveguide of claim 14, wherein the means for supporting the hollow tube comprises a series of rings.

18. A method comprising: placing a spring inside a fine tube, and bending the fine tube together with the inner spring, wherein the inner spring is sufficiently rigid to resist significant collapse of the fine tube during the bending.

19. The method of claim 18, further comprising the step of shrinking the fine tube to tightly surround the spring.

20. The method of claim 18, further comprising the step of placing a securing material over the bent fine tube with the inner spring.

21. The method of claim 20, wherein the step of placing the securing material over the bent fine tube comprises a process selected from the group of: mold injection, casting, or extrusion coating.

22. A method comprising: placing a wire inside a spring, bending the spring with the inner wire, and placing a securing material over the spring, wherein the inner wire prevents the securing material from entering inside the spring.

23. The method of claim 22, further comprising the step of pulling out the wire.

24. A method for manufacturing a fine curved acoustic waveguide, comprising curving a tightly coiled spring into a required shape, and placing a high viscosity securing material over the tightly coiled spring, wherein the high viscosity prevents the securing material from entering into the fine acoustic wave guide inside the tightly coiled spring.

25. The method of claim 24, wherein the step of placing the securing material over the curved tightly coiled spring comprises performing a process selected from the group of: mold injection, casting, or extrusion coating.

26. A method for manufacturing a fine curved acoustic waveguide, comprising placing a fine tube inside a helix spring, bending the helix spring with the fine tube inside, and placing a securing material over the helix spring.

27. The method of claim 26, further comprising the step of placing a wire within the fine tube, whereby the wire prevents the fine tube from collapsing while the acoustic waveguide is bent.

28. The method of claim 27, further comprising the step of pulling out the wire from within the fine tube.
